(19) United States
(12) Patent Application Publication
(10) Pub. No.: US 2018/0198693 A1
(43) Pub. Date: Jul. 12, 2018

(54) SYSTEM AND METHOD OF TROUBLESHOOTING NETWORK SOURCE INEFFICIENCY

(71) Applicant: Vivek Pathela, Saratoga, CA (US)

(72) Inventor: Vivek Pathela, Saratoga, CA (US)

(21) Appl. No.: 15/741,486

(22) PCT Filed: Dec. 7, 2016
(86) PCT No.: PCT/US2016/065386

§ 371 Date: Jan. 2, 2018

Related U.S. Application Data
(60) Provisional application No. 62/272,503, filed on Dec. 29, 2015.

(30) Foreign Application Priority Data
Nov. 3, 2016 (US) 15343026

(51) Int. Cl. H04L 12/26; G06F 11/07; H04B 15/02; H04W 52/24

(52) U.S. Cl. CPC H04L 43/08; G06F 11/0709; G06F 11/0751; H04L 43/16; G06F 11/0793; H04B 15/02; H04W 52/24; G06F 11/079

(57) ABSTRACT

A system, processes, and a software as a service application gathers diagnostics and metrics in real-time from connected devices in a network, highlights what inefficiency issues exist in the network, and transforms them into actionable insights to improve performance. The embodiments identify sources of performance degradation at one or more of the end user devices and analyzes for solutions to rectify the degradation. In some embodiments, the source of degradation is identified by analyzing performance of other devices in proximity to the end device showing performance degradation. Thus solutions may involve removing or fixing the problem from an adjacent device which then shows improved performance in the end device showing degradation.

### CROSS-REFERENCE TO RELATED APPLICATIONS

This application is a National Stage Entry of International Application serial number PCT/US2016/065383 filed on Dec. 7, 2016, which, in turn, claims priority to U.S. Provisional Application having Ser. No. 62/272,503 filed Dec. 29, 2015. The entire contents of both applications are hereby incorporated by reference herein in its entirety.

### BACKGROUND

The embodiments herein relate generally to networks, and more particularly, to a system and method of troubleshooting network source inefficiency.

Devices like home routers, smart TVs, wearables, commercial and industrial sensors that connect to the Internet are functioning in silos with little or no information coming back to the developers or support technicians for these devices on what may be going wrong with it and what are the conditions it is operating in, such as the WiFi wireless interference conditions and the available bandwidth between the device and the content it is accessing on the Internet. When a problem occurs users and support technicians have a very difficult time to pinpoint what is causing the failure, disconnection or poor performance of the application used at that device. Hence, they take excessive time to troubleshoot and fix issues with connected devices.

The limitations of alternative solutions in the field are: 1) the IOT cloud platform providers are primarily enabling devices to become cloud connected for remote application access, 2) Broadband Service Providers have remote access to their broadband modems, gateways and setup boxes, but use software and infrastructure that are proprietary, non-Internet, limited and slow response called TR69, 3) enterprise software visualization and analytics companies do not support connected devices and the internet of things and focus primarily on applications and apps.

### SUMMARY

According to one embodiment of the present invention, a process for troubleshooting inefficiencies in a network comprises sending probe messages to devices in the network; detecting responses to the probe messages; identifying outages in the network based on a lack of response to the probe messages and issuing an alert indicating an outage; sending diagnostic testing messages to points in the network that responded to the probe messages, the diagnostic testing messages measuring network related performance from each of the points; analyzing measured network performance data received from each of the points; identifying sources of network performance inefficiency from the analyzed measured network performance data; and providing a solution for correcting the identified sources of network performance inefficiency.

### BRIEF DESCRIPTION OF THE FIGURES

The detailed description of some embodiments of the present invention is made below with reference to the accompanying figures, wherein like numerals represent corresponding parts of the figures.

FIG. 1 is a block diagram of a network system for troubleshooting sources of inefficiency in accordance with an exemplary embodiment of the subject technology.

FIG. 2 is a high level flowchart of a process for troubleshooting devices in the system of FIG. 1 in accordance with the subject technology.

FIG. 3 is a flowchart of a method of testing for sources of error in accordance with an exemplary embodiment of the subject technology.

FIG. 4 a flowchart of a method of processing troubleshooting at an IoT end device level in accordance with an exemplary embodiment of the subject technology.

FIG. 5 is a flowchart of a method of identifying a source of performance degradation in accordance with an exemplary embodiment of the subject technology.

FIG. 6 is a flowchart of a method of checking for a service provider outage in accordance with an exemplary embodiment of the subject technology.

FIG. 7 is a flowchart of a method of processing troubleshooting at an access point in accordance with an exemplary embodiment of the subject technology.

FIG. 8 is a flowchart of a method of processing data gathered from network connected devices in accordance with an exemplary embodiment of the subject technology.

FIG. 9 is a flowchart of a method of determining speed and latency problems at the IoT device level in accordance with an exemplary embodiment of the subject technology.

FIG. 10 is a block diagram of a general computing device in accordance with an exemplary embodiment of the subject technology.

FIG. 11 is a screen display of devices that are identified as having performance degradation problems for analysis within a network of an embodiment of the subject technology.

FIG. 12 is a screen display showing root cause analysis for performance degradation in a device in the network in accordance with an exemplary embodiment of the subject technology.

FIG. 13 is a screen display showing analysis of Wi-Fi performance in a device in the network in accordance with an exemplary embodiment of the subject technology.

FIG. 14 is a screen display showing devices sharing wireless bandwidth in the network in accordance with an exemplary embodiment of the subject technology.

FIG. 15 is a screen display showing a list of troubleshooting results and automatic actions performed by the system for a device showing performance degradation in the network in accordance with an exemplary embodiment of the subject technology.

### DETAILED DESCRIPTION OF CERTAIN EMBODIMENTS

In general and referring to the Figures, embodiments of the subject technology provide a system, processes, and in some embodiments, a software application which gathers diagnostics and metrics in real-time from connected devices and the live environment. The embodiments identify and flag inefficiency issues in the devices and the operating environment. Sources of the inefficiency are identified and actionable insights into remediating the sources of performance degradation are provided to resolve the inefficiencies. As will be appreciated, features in the embodiments disclosed go beyond simply identifying a device or network point with data loss or data degradation. Unlike the prior art which approaches networking inefficiencies one symptom at a time, embodiments herein improve the field of computer/device networking by providing a holistic approach, which correlates various factors that may in combination trigger a drop in network performance. Exemplary embodiments analyze the hardware and software operating elements at the end device level, the network switching level, and in the operating environment to pinpoint one or more contributions to performance degradation. Aspects disclosed help manufacturers to improve their products, improve the user experience and substantially lower the costs of support and operations.

In an exemplary embodiment, a software process correlates information from different sources of data along different points and levels of connectivity to automatically detect, isolate, and remediate a failure, fault or problem experienced by a connected device or application. For example, performance data and checks may be performed at a cloud based level of connection, at a wireless router level, and at an Internet of Things (IoT) device level. Various aspects (devices, connections, and performance) of the connected environment are examined in their live and operating condition to identify an issue, narrow down the source of the problem, and prescribe a solution to the issue.

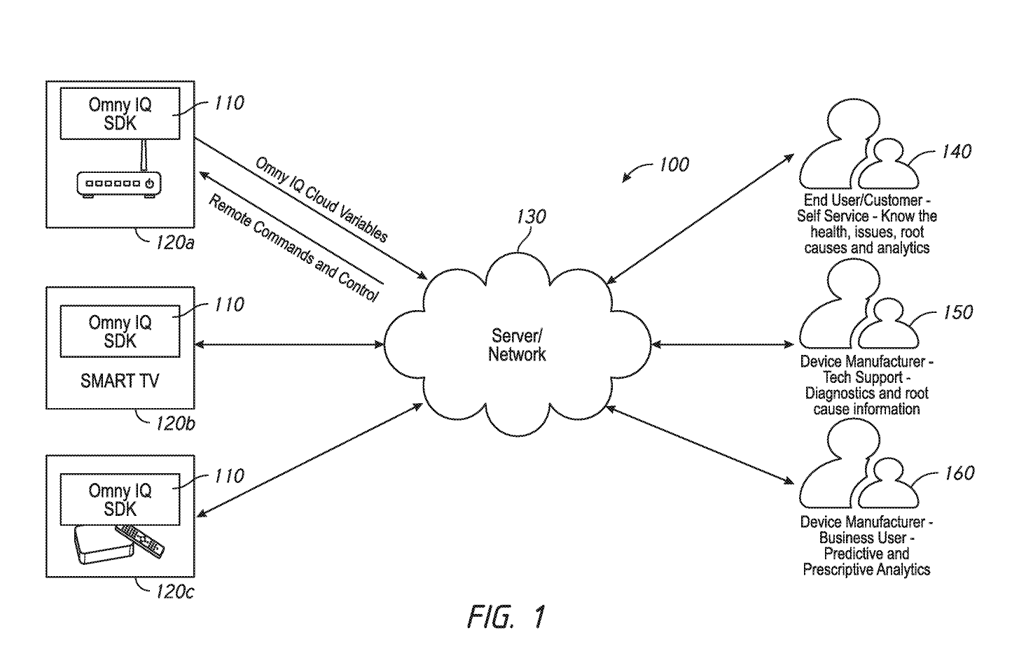

FIG. 1 shows an exemplary network 100 including end devices 120a (a wireless router), 120b (a smart television), and 120c (a streaming video device) incorporating operating software 110 according to embodiments disclosed herein. It will be understood that the end devices 120a, 120b, and 120c are just some examples of end devices within the IoT of connected devices and other IoT connected devices are contemplated herein. As will be appreciated, aspects of the subject technology do more than just identify a network bottleneck or fault at a switching point. Aspects evaluate points of connectivity for environmental factors which may be the underlying cause of inefficiency that normally escape current network troubleshooting technologies. In some embodiments, the software 110 is loaded into the end devices 120a, 120b, and 120c and in a cloud based server system 130. Aspects of the subject technology monitor the performance in the end devices 120a, 120b, and 120c and in the software operating the device (which may be integrated with or distinct from the software 110). Some embodiments may use a centralized server/platform or a cloud based system 130 for monitoring, detection, diagnostic remediation, and transmission of solutions.

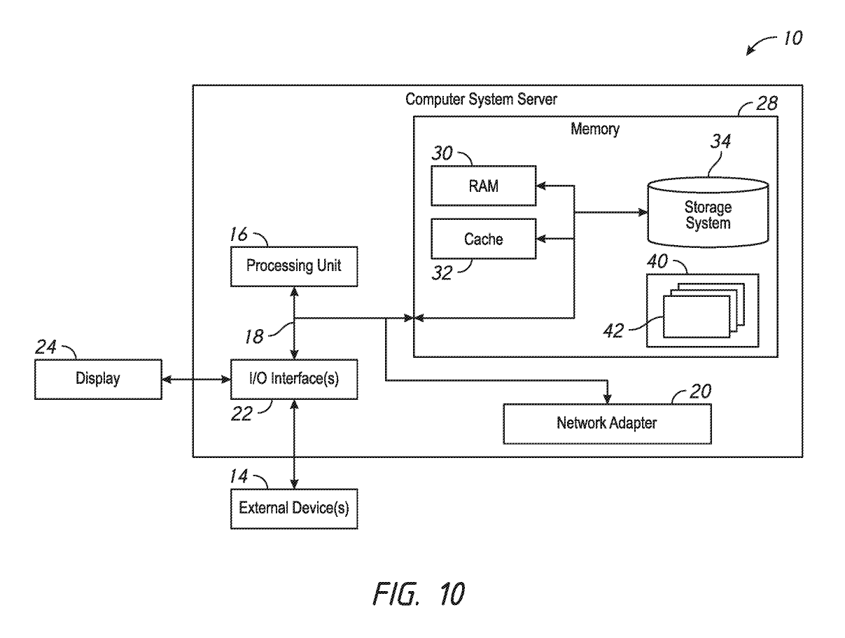

The cloud based server system 130 (referred to generally as the “system 130”) may include a central computer server or a distributed server (described more fully below in FIG. 10). In general, detected issues are identified and recommended solutions are provided from the cloud based server system 130 to users 140 (for example, an end user/customer), users 150 (for example, a device manufacturer or technical support personnel, and users 160 (for example, a device manufacturer business user). The system 130 may send remote commands to end devices 120a, 120b, and 120c to gather diagnostic data. Based on the results of the diagnostic data, the system 130 may issue an alert for a drop in performance and a solution for resolving the degradation of performance. For example, average data speed of a device 120a, 120b, and 120c is recorded for various times of day. Detection of speed lower than the average may automatically trigger investigation. Another example of automatic detection involves changes in devices connected to a network point such as a router that affects the end devices 120a, 120b, and 120c. When the end devices 120a, 120b, and 120c return (or fail to return) expected performance metric data or replies, the system 130 may check for connectivity variables that may affect the end devices 120a, 120b, and 120c. Connectivity variables may include for example, service status, the number of shared devices connected to a common network point and wireless devices within range of a network point. As will be appreciated, aspects of the disclosed processes may identify sources of inefficiency that are typically unidentified including for example: a newly connected (or unauthorized connected) device to a network point (which may be for example consuming an unexpected or inordinate amount of bandwidth), the number of devices connected to a network point exceeding an average number of daily connected devices, flagging devices channeling the most data through a network point, wireless signal strength from device(s) that deviate from a daily average strength, the amount of daily wireless activity from a device, and interference of overlapping signals from wireless devices in proximity of each other. The details of these features are shown in the flowcharts described below.

It will be understood that actions described in the following processes may be performed (unless otherwise specified) by system components including for example, a computer processor as described in more detail below with respect to FIG. 10.

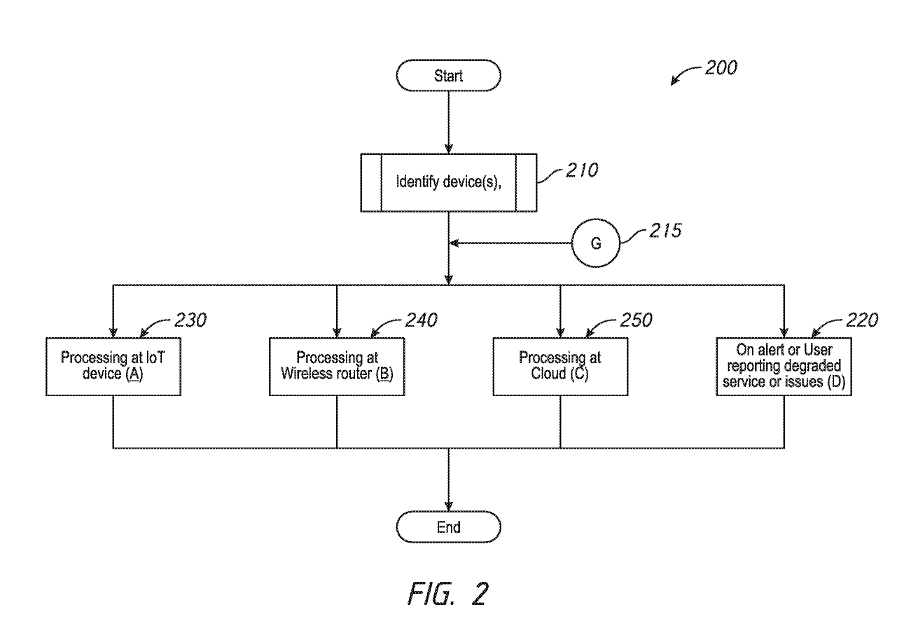

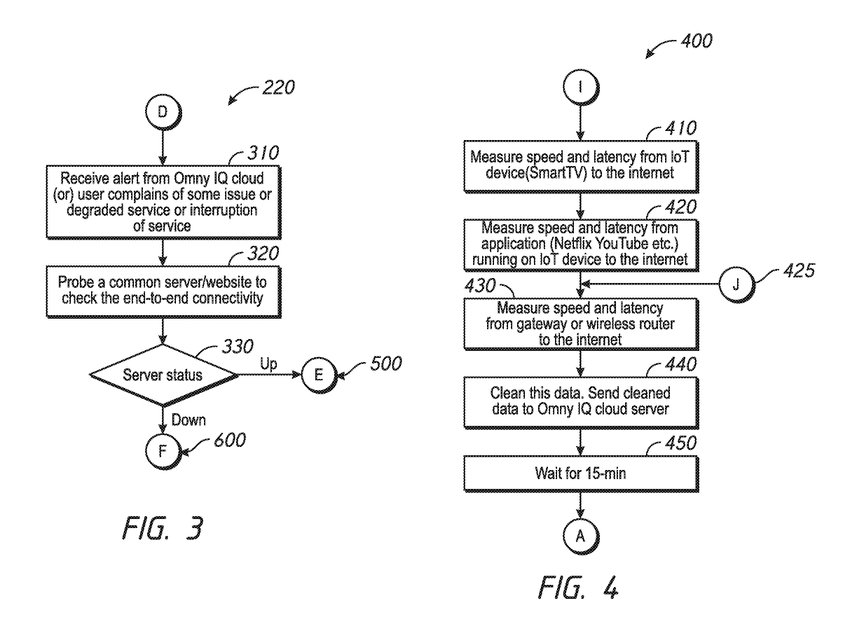

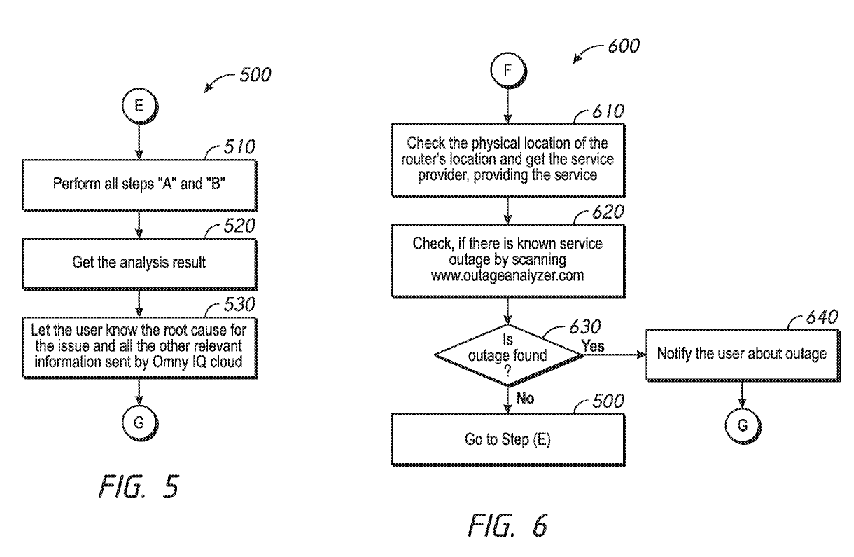

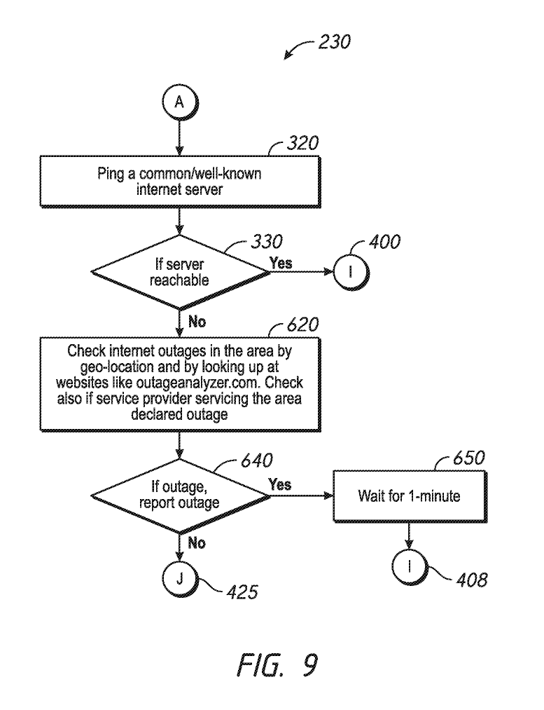

Now referring to FIG. 2 concurrently with FIGS. 3-9, a process 200 for troubleshooting network inefficiencies and sub-processes 300, 400, 500, 600, 700, 800, and 900 therein are shown. FIG. 2 shows an overall process 200. The process 200 describes how for example, a software embodiment troubleshoots connectivity issues of connected devices like a Smart TV or a LTE-cellular connected outdoor sensor or an application like a Netflix® video stream from a smart TV. After identifying 210 devices of interest in the network, an alert from agent software, (for example software 110 of FIG. 1) on and end device (for example, a Smart TV or sensor) flags the response time of an application running on the network (for example, a video stream on the Smart TV) as being below an accepted threshold. In response to the alert and depending on the specific details of the alert, one of sub-processes 220, 230, 240, and 250 are performed. In an exemplary embodiment, process 220 is generally performed first however it will be understood that any of the processes 220, 230, 240 or 250 may be run first depending on the data received from the end device. The sub-processes in blocks 220, 230, 240, and 250 are shown in FIGS. 3, 9, 7, and 8 respectively. The process in block 220 relates to remedying a networking problem in response to a system issued alert or user reported problem. The process in block 230 relates to troubleshooting at an end device. The process in block 240 relates to troubleshooting at an access point, for example a wireless router. The process in block 250 relates to processing the data gathered for example by all sources in a connected network to identify sources of inefficiency and potential resolutions. FIGS. 5 and 6 show sub-routines as a result of the process shown in FIG. 3. FIG. 4 is a sub-process performed depending on the results of the process 230 in FIG. 9.

Referring to FIG. 3, the sub-process 220 is shown in more detail according to an exemplary embodiment. Process 220 performs a connection test(s) to determine whether the connectivity issue is beyond the device's local area network or at the device level. Process 220 includes a step of receiving an alert 310 either from the system 130 or from a user reported instance of degrading service performance or interruption of service. For example, a service entity providing troubleshooting support for devices that participate in the system 130 may receive contact from a customer initiating a request to investigate the performance of their device's connectivity to the network. An administrator or technician with access to the cloud system 130 may initiate 320 diagnostic testing for the device and/or network. As an initial inquiry, the process 220 checks for server status through which the device's Internet connection is running to immediately rule out a high level connection issue. For example, a common website or server may periodically be probed from the device or application in question to check whether that server is up or down. In some embodiments, the software integrated into the end device may automatically periodically transmit data about its performance and the surrounding environment. For example, an internal diagnostic process in the end device may periodically measure current network connection speeds and wireless signal interference levels. In other embodiments, the host server system may send a request to the device for the latest performance data and environmental conditions, which may initiate a diagnostic test and/or trigger the device to transmit the data to the host server system. A determination of the operational status of the server is made 330. If the server is reachable and up, the Internet connection is assumed to be up. The process 220 may proceed to sub-process 500 of FIG. 5 described below. If the server is not reachable, the process 220 may proceed to sub-process 600 of FIG. 6 described below.

Referring to FIG. 6, after a determination that a server may be down, the system may check 610 for known connection issues with the physical location of the public IP address associated with the router the device/application is connected to. Using for example a popular ISP IP lookup and WiFi AP lookup which are publicly available, the physical location of the router may be determined. If the physical location of the user's router is not found, the service provider may be located and checked to see if the provider declared an outage for the user's area or slow performance, etc. If the router's location is found, the system may compare 620 the location of the router to an outage list and map listed on the Internet. If the address is listed in one of the outage areas, the outage information may be recorded as an Internet outage issue. The system may note that there is no issue with user's router and may notify 640 the user of the outage. If an outage is not present, the system may determine that there may be a problem with the user's router connecting to the Internet. The process 200 may proceed to process 500.

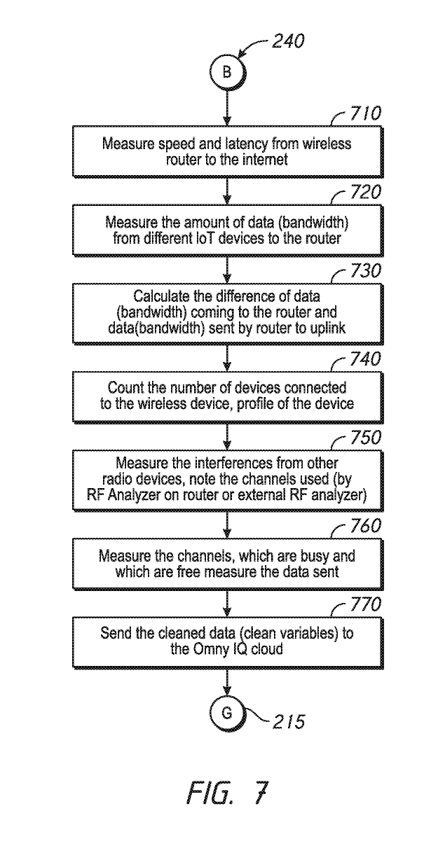

Referring now to FIG. 5, process 500 of troubleshooting device or application performance may begin at block 510 that includes performing two additional sub-routine processes; 230 and 240. Process 230 is shown in FIG. 9. Process 240 is shown in FIG. 7. Once processes 230 and 240 are performed, results of the analysis are retrieved 520 and reported 530 to the end user. The report may include data such as the speed, latency and ping results associated with the device. The source of the problem may be identified and the process may loop to block 215 in the overall process 200 of FIG. 2. The following describes the processes 230 and 240 which include further sub-processes depending on the results of determinations within process 230.

Referring now to FIG. 9, the process 230 for troubleshooting at an IoT device level is shown according to an exemplary embodiment. The process 230 is generally similar to the processes in FIGS. 3 and 6. The process 230 may probe 320 an Internet server to check for a server outage. If the server does not appear to be reachable, the system may check 620 for Internet or service provider outages in the device's area. Confirmed outages may be reported 640 to the user customer. In some embodiments, the process 230 may repeatedly check for example in 1 minute increments as to whether the outage persists before proceeding to process 400. If no outage is detected, the process may proceed to block 425 in process 400.

Referring now to FIG. 4, a process 400 for troubleshooting speed/latency issues at the IoT device level is shown according to an exemplary embodiment. The process 400 may measure 410 the speed from the IoT device. Latency of the device may be measured by issuing a probe (“ping”) to a common website. The speed of a running application process on the device may be measured 420 by running for example a video streaming program. The speed of the wireless router, gateway, or cellular base station (other network hubs) to the Internet may be measured 430 by collecting the total volume of traffic in increments (for example 10 second increments) and calculating the speed based on the average volume per second. The collected speed/latency data from block 410, 420, and 430 may be cleaned and formatted for transmission 440 to the cloud system server 130. In addition to the speed measurement at the time of the problem being reported, the speed/latency measurements may be run 450 every 15-min to provide a trend chart of speeds at different times of the day and on different days. The speeds may be benchmarked with respect to mean and median speeds. Average speed at that time of the day over last 1-month also may be calculated and stored. Any anomalies that deviate from the average speed at that time of the day is captured and flagged.

Referring now to FIG. 7, the process 240 is shown according to an exemplary embodiment. The process 240 is generally performed on a wireless router connected to the device/application being diagnosed. The process may measure 710 the wireless router's speed and latency. For example a “ping” may be sent to a point of the Internet from an IoT end device (for example, a smart TV), or the wireless router gateway, or cellular base station (other network hubs). The latency may be recorded for that instance. In some embodiments the latency is measured every 15-min. A trend chart is captured for different times of the day so the latency is benchmarked with respect to mean and median speeds. Average speed at the time of the day the measurement is taken over last 1-month may be recorded as well. Any anomalies that deviate from the average speed at that time of the day may be identified and flagged.

The process may measure 720 the combined bandwidth of all data coming to the router from various IoT devices at an instant. The process may measure 730 the difference in bandwidth data incoming to the wireless router from the amount of bandwidth sent by the router to an uplink. This may be performed by measuring the bandwidth from the gateway to the Internet and measuring the bandwidth from the gateway to each of the IoT devices. If the combined bandwidth generated by all devices to the router is higher than an uplink/WAN bandwidth, the measurement is flagged. This may be run every 15-min and whenever the event occurs, it may be flagged. A trend chart with both data sent to the router and data sent from router to uplink should be clearly shown.

The process may identify 740 the number of devices connected to the wireless router. Each connected device may be identified by type of device and recorded. This is checked every 15-min and a trend chart of number of devices connected to the router is recorded. The average number of devices connected to the router at that time of day may be measured and any deviations from the usual number of devices that are connected to the router daily may be flagged. In some embodiments, the data sent by each device to the router may be measured at an instant and also every 15-min. The process may track and record devices that send the most amount of data and identify trends in the amount of data sent by each device.

The process may use an RF Analyzer (WiFi, LTE Cellular or other wireless) to measure 750 interference of neighboring signals and overlapping channels from radio enabled devices within proximity of each other. The activity for each wireless/radio device may be tracked for trends and channels used by different access points and base stations. This may be measured at intervals and deviations from an average may be flagged. The process may measure 760 the amount of wireless signals and channels used for each wireless radio enabled device. The system may detect whenever a channel is very busy during different times of the day and which days are different than normal when compared to historical data. In some embodiments, the process may measure the data sent though wireless channels from devices other than a device being currently analyzed. The system may record and track trends of data sent through different channels at different times of the day and on different days for the other devices. In some embodiments, a device running a software embodiment may record the performance data from the device being monitored and the next devices connected to said device. The process may then track the information upstream from the device as performance data makes its way to the host server system. Using the information from the device running the subject technology, expected performances can be extrapolated for devices connected to the device being monitored. For example, software running on a router using aspects of the subject technology may record the router's performance data (including for example, wireless interference data and available transmission capacity). As the performance data is uploaded through the network to the host server system, the information may also include wireless signal strength for the router and link rate (speed) between the router and each device connected to the router. For other devices in the network, the expected performance of each device along a network path may be determined and deviations from the expected performance may be flagged. If the other connected devices are also using the subject technology, similar information from each connected device and the router may be evaluated to determine sources contributing to underperformance. The Wi-Fi signal strength from the router (gateway/base station) to each of the other devices may be measured periodically to determine trends. A deviation from usual signal strengths may be flagged. Data may be cleaned and formatted for presentation to the cloud server system 130 for analysis and remediation. The process 240 may return to the overall process 200 at block 215.

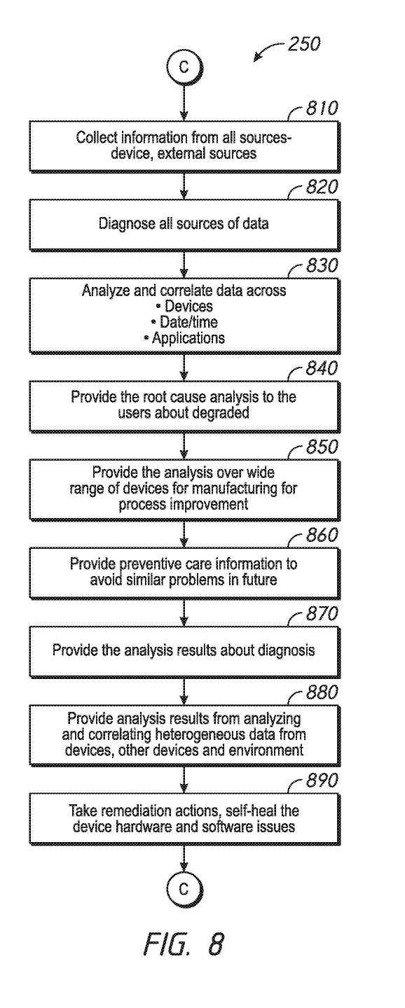

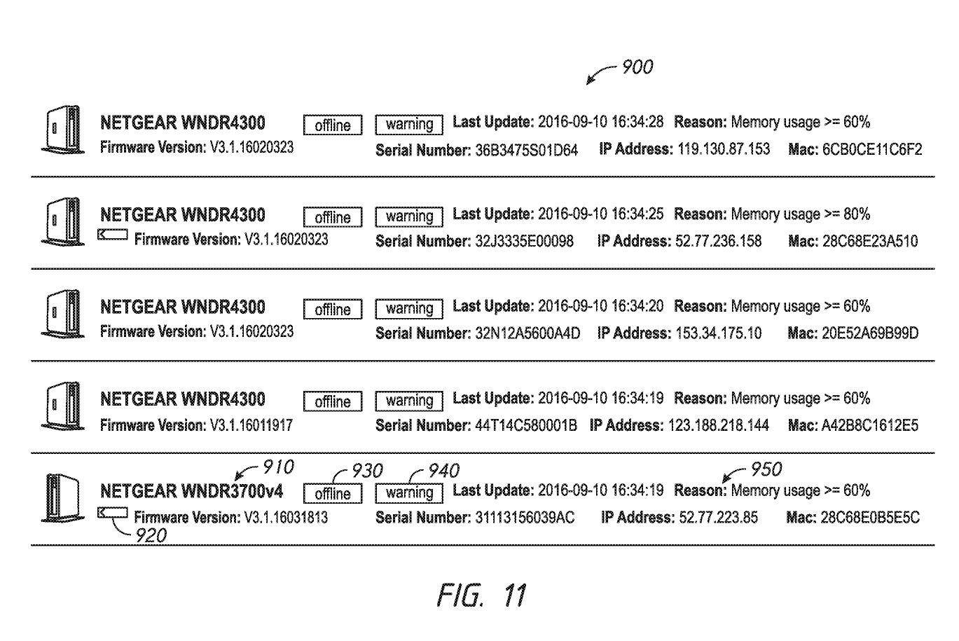

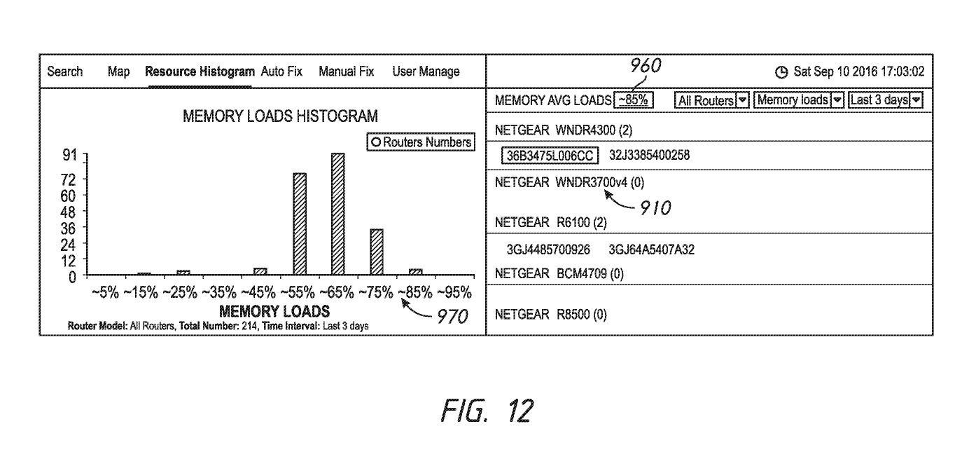

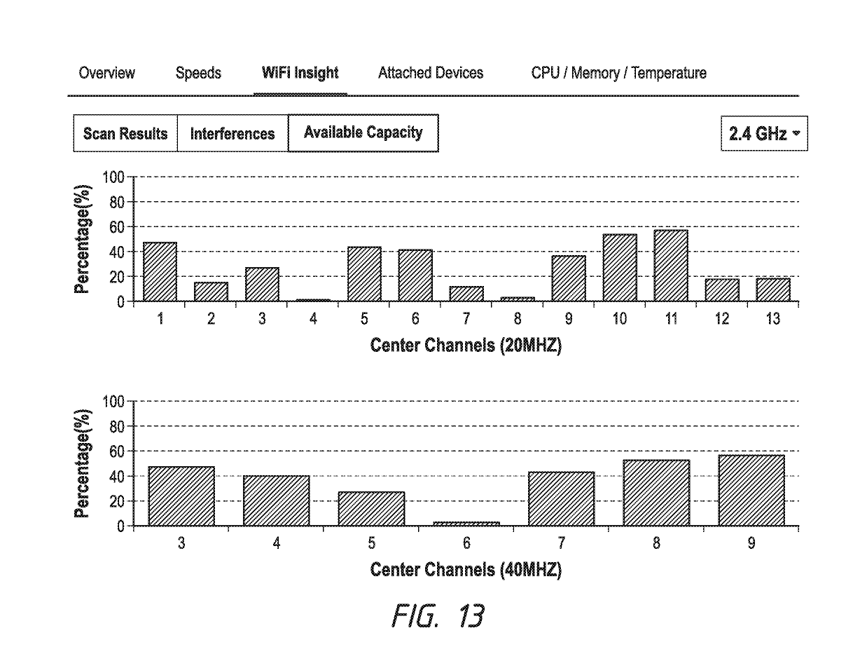

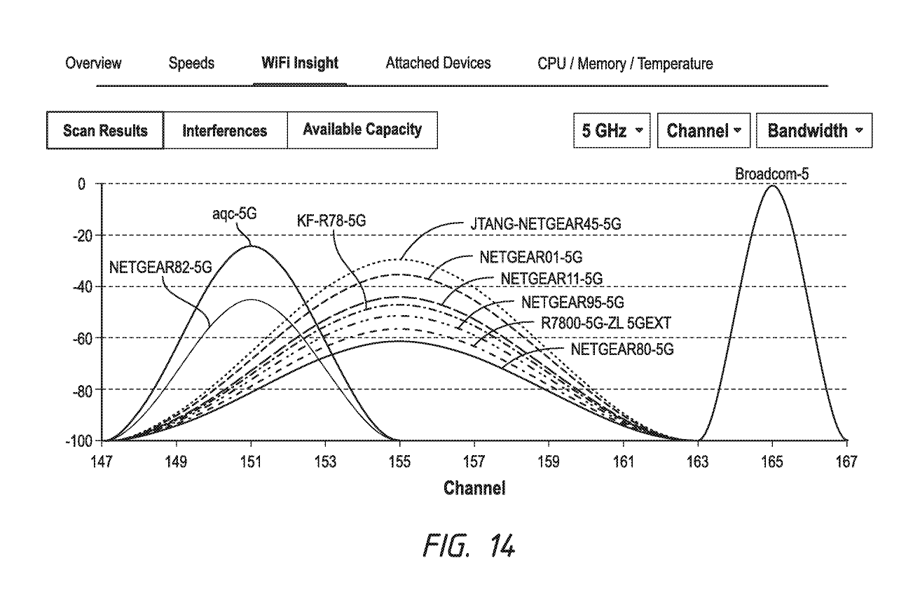

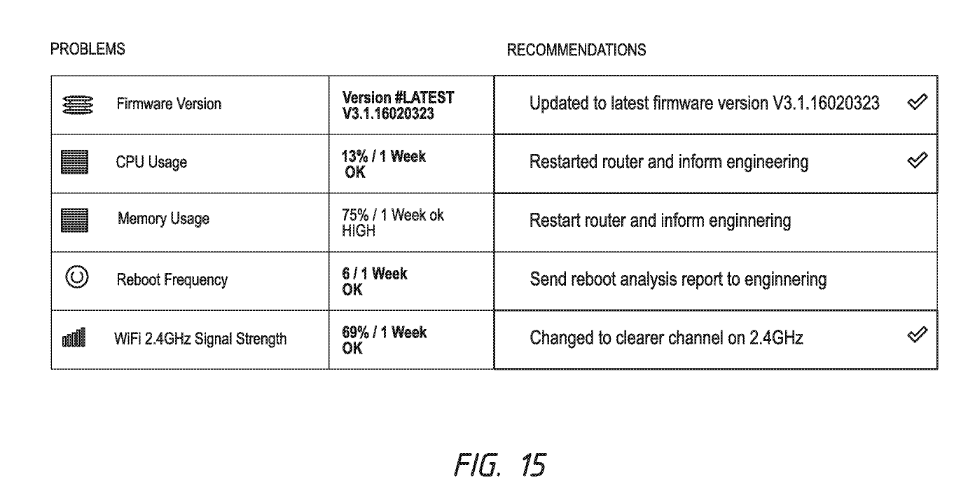

Referring now to FIG. 8, the process 250 for identifying a source of performance degradation is shown according to an exemplary embodiment. Data may be collected 810 from end devices in the network system and external sources (for example, service providers, neighboring devices, etc.). The sources of collected data may be diagnosed 820 for changes in performance and data showing degradation may be identified. The collected data may be analyzed and correlated 830 with respect to device, date/time of data collection, and applications running by/through the device. For an identified drop in device performance, a root cause of performance degradation including analysis showing changes in performance may be provided 840 to end device users. FIGS. 10-15 show a series of exemplary screenshots that provide performance data, indicators of performance degradation, and troubleshooting recommendations as a result of aspects of the subject technology. Performance data degradation may be based on the performance of wireless device point or computing device, or a component within a device such as a processing unit, a volatile memory module, a non-volatile memory module or a thermal rating of the device/processing unit/or memory module. For example, FIG. 10 shows a set of routers connected to the network which are identified for having performance degradation and are currently offline. Each router has either a warning or an error status attached to it along with a reason the device was either taken offline or became offline of its own accord. For example, router 910 shows a firmware version status that is out of date, an online/offline status 930 that is currently offline, an alarm indicator 940 showing a warning status, and a root cause field 950 that display a reason that may be contributing to the devices offline status. FIG. 11 shows a display with in depth analysis of the root cause for the router 910. The display shows for example, the average memory loads, which in this case has been exceeding 85% too often during the device's operation as shown in the histogram 970. Another characteristic which may be identified and tracked is wireless performance among devices in a physical proximity of each other. FIG. 12 shows the available bandwidth for a wireless device operating in the 2.4 GHz band. FIG. 13 shows scan results displaying which devices in a network are operating for example, on the 5 GHz band whose signal is centered near the same channel. This may provide insight into which devices may be operating too near the same channel causing signal interference among each other. As can also be seen, some embodiments include a tab that shows the interferences between devices. FIG. 14 shows a screen display of an exemplary page showing recommendations to fix performance issues found on a device in the network. Root causes such as excessive memory usage and device reboot frequency occurring too often may trigger an automatic action such as restarting the router remotely by the system and sending reports to third parties about the analysis performed by the system.

The performance degradation analysis may be applied to a wide range of devices including devices using aspects of the subject technology and other devices connected to the devices using the subject technology. For other devices, indirect measurements may be extrapolated based on the uploaded performance data of devices using the subject technology being transmitted upstream or downstream from the other devices. As described above with respect to process 700, software embodiments may capture information in a router related to the link rate, available capacity and expected performance over time of client/IOT devices that connect to the router. In addition, software in the router also captures environmental conditions of the WiFi, Internet, internet video streaming quality, video call quality, online gaming quality, and audio conferencing quality to know what kind of performance and reliability can be expected from each device in the network path. The performance degradation analysis which may identify sources contributing to bottlenecks in a network may be provided 850 to manufacturers. For example, a displayed comparison between the available Internet bandwidth, outages, and used traffic through the LAN and WAN communication, as well as wireless channel interferences and available capacity may provide engineers with quick identification of how their product behaves in a network with other devices. This information may thus be used to modify and improve the performance of future products. In some embodiments, preventive care information may be provided 860 to both manufacturers (as a preventive care resource) and to end users (as a self-care type product) so that similar causes of performance data may be avoided in the future. The analysis of performance degradation may be provided 870 [to manufacturers that need a deeper dive analysis to identify what is triggering the problem within the device they manufacture. Heterogeneous data from network devices, other devices, and the environment in which devices reside may be analyzed and correlated which may then be provided 880. The system may remedy 890 the identified source(s) of performance degradation. In some embodiments, remediation may be automatic in that the end device with a software embodiment residing in the device may perform self-healing actions. These include for example: triggering the device to restart/reboot; switching the operating channel for a WiFi device; changing the transmission power of a radio; changing the orientation of an antenna for a radio enabled device; upgrading or downgrading software in the device; turning off the device for a certain time; restarting or stopping a running process in the device; changing log settings; deleting files; and changing device configuration.

Referring now to FIG. 10, a schematic of an example of a computer system/server 10 is shown. The computer system/server 10 is shown in the form of a general-purpose computing device. The components of the computer system/server 10 may include, but are not limited to, one or more processors or processing units 16, a system memory 28, and a bus 18 that couples various system components including the system memory 28 to the processor 16.

The computer system/server 10 may perform functions as different machine types depending on the role in the system the function is related to. For example, in some embodiments, the computer system/server 10 is one of the end user devices 120a, 120b, or 120c as described above in FIG. 1. In other embodiments, the computer system/server 10 is one or more host servers 130 (FIG. 1) communicating with the end devices 120a, 120b, 120c and performing the various troubleshooting processes described above. The computer system/server 10 may be for example, personal computer systems, tablet devices, mobile telephone devices, server computer systems, handheld or laptop devices, multiprocessor systems, microprocessor-based systems, set top boxes, programmable consumer electronics, network PCs, and distributed cloud computing environments that include any of the above systems or devices, and the like. The computer system/server 10 may be described in the general context of computer system executable instructions, such as program modules, being executed by a computer system (described for example, below). In some embodiments, the computer system/server 10 may be a cloud computing node connected to a cloud computing network. The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device. The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described above such as in FIGS. 2-9.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶ 6. In particular, any use of “step of” in the claims is not intended to invoke the provision of 35 U.S.C. § 112, ¶ 6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A process for troubleshooting inefficiencies in a network, comprising:
sending probe messages to end user devices via the Internet and/or a wireless telecommunications network;
detecting responses to the probe messages;
receiving diagnostic data from the responses to the probe messages;
identifying performance degradation in one or more of the end user devices based on the received diagnostic data, the performance degradation based on excess CPU consumption, memory consumption, or reboot frequency in said end user device;
issuing an alert indicating the identified performance degradation;
sending a diagnostic test message to a point in the network associated with the end user device associated with the identified performance degradation, wherein the point in the network is in communication with the end user device associated with the identified performance degradation when said end user device is normally not associated with the performance degradation;
determining whether the point in the network is a source of the identified performance degradation; and
providing a solution for correcting the source of the identified performance degradation, in response to the point in the network being the source of the identified performance degradation.

2. The process for troubleshooting inefficiencies in a network of claim 1, wherein the end user device associated with the identified performance degradation is one of a processing unit, a volatile memory module, a non-volatile memory module or a thermal rating of the device.

3. The process for troubleshooting inefficiencies in a network of claim 1, wherein the point in the network is an Internet service provider, and wherein the process further comprises checking the Internet service provider for a service outage in a geographical area of the end user device associated with the identified performance degradation.

4. The process for troubleshooting inefficiencies in a network of claim 1, wherein the end user device associated with the identified performance degradation is one of a personal computer, a smart television, and a radio enabled device.

5. The process for troubleshooting inefficiencies in a network of claim 4, further comprising changing a transmission power of the radio enabled device as the solution for correcting the source of the identified performance degradation.

6. The process for troubleshooting inefficiencies in a network of claim 4, further comprising changing an orientation of an antenna of the radio enabled device as the solution for correcting the source of the identified performance degradation.

7. The process for troubleshooting inefficiencies in a network of claim 1, wherein the end user device associated with the identified performance degradation is a router and the process further comprises:
identifying a wireless device added to a list of devices previously connected to the router;
determining said wireless device is consuming bandwidth at a rate, in aggregate with the list of devices previously connected to the router, that exceeds a bandwidth limit of the router; and
sending a notice to an administrator associated with the router identifying said wireless device being connected to the router.

8. A process for troubleshooting inefficiencies in a network, comprising:
tracking an average number of devices connected to a router in the network;
detecting a number of devices connected to the router exceeding the average number of devices connected to the router;
triggering an alert when the average number of devices connected to the router is exceeded; and
generating a message to a network administrator including the triggered alert.

9. The process for troubleshooting inefficiencies in a network of claim 8, further comprising:
determining which device(s) of all devices connected to the router are channeling the most data through the router when the average number of devices connected to the router is exceeded; and
flagging the device(s) determined to be channeling the most data through the router in a message generated for a network administrator.

10. The process for troubleshooting inefficiencies in a network of claim 8, further comprising:
determining if one or more of devices connected to the router is unauthorized for connection; and
disconnecting the one or more unauthorized devices.

11. The process for troubleshooting inefficiencies in a network of claim 10, further comprising:
identifying authorized devices connected to the router; and
automatically changing the password for the router and update password data for connection to the router in identified authorized devices.

12. A process for troubleshooting inefficiencies in a network, comprising:
sending a probe message to an network connected device in the network;
detecting a response to the probe message;
running a streaming data application from an Internet based website on the network connected device;
measuring speed of data transfer of the network connected device running the streaming data application;
measuring latency of the network connected device running the streaming data application;
comparing the measured speed of data transfer and measured latency to stored average speeds of data transfer and stored average latency measurements for the network connected device;
determining whether the measured speed of data transfer and measured latency deviate greater than a threshold amount from the stored average speeds of data transfer and stored average latency measurements for the network connected device; and
sending a notice to an administrator associated with the network connected device of measured speeds of data transfer and measured latency deviating greater than the threshold amount.

13. The process for troubleshooting inefficiencies in a network of claim 12, wherein the network connected device is a wireless router and the process further comprises:
measuring an amount of bandwidth transferred from end devices connected to the wireless router;
calculating a difference of bandwidth between the measured amount of bandwidth transferred from end devices connected to the wireless router and bandwidth uplinked from the wireless router to a gateway server; and
including the calculated difference in the notice sent to the administrator.

14. The process for troubleshooting inefficiencies in a network of claim 13, further comprising:
identifying the end devices wirelessly connected to the wireless router;
measuring radio frequency interference levels from other radio enabled devices for one or more of the end devices; and
adjusting a wireless transmission channel of the wireless router to reduce the radio frequency interference levels.

15. The process for troubleshooting inefficiencies in a network of claim 13, further comprising:
identifying the end devices wirelessly connected to the wireless router;
measuring radio frequency interference levels from other radio enabled devices for one or more of the end devices; and
adjusting a transmission power level of the wireless router to reduce the radio frequency interference levels.

16. The process for troubleshooting inefficiencies in a network of claim 13, further comprising:
identifying the end devices wirelessly connected to the wireless router;
measuring radio frequency interference levels from other radio enabled devices for one or more of the end devices; and
turning off one or more of the radio enabled devices in response to radio interference levels from the one or more radio enabled devices degrading the measured speed of data transfer and measured latency deviating greater than the threshold amount, wherein the radio enabled devices are connected to the network.
